(19) United States
(12) Patent Application Publication
(10) Pub. No.: US 2015/0143361 A1
(43) Pub. Date: May 21, 2015

(54) SOFTWARE ROAMING SYSTEM, METHOD AND COMPUTER READABLE STORAGE MEDIUM THEREOF

(71) Applicant: INSTITUTE FOR INFORMATION INDUSTRY, TAIPEI (TW)

(72) Inventors: Shen-You CHAI, Tainan City (TW); Yung-Yi HUANG, Nantou County (TW); Dze-Min JOU, Taipei City (TW)

(73) Assignee: INSTITUTE FOR INFORMATION INDUSTRY, TAIPEI (TW)

(21) Appl. No.: 14/098,540

(22) Filed: Dec. 6, 2013

(30) Foreign Application Priority Data
Nov. 19, 2013 (TW) 102142079

(51) Int. Cl. G06F 9/445

(52) U.S. Cl. CPC G06F 8/61
USPC 717/177

(57) ABSTRACT

A software roaming system, method and a computer readable storage medium thereof are disclosed herein. The software roaming system includes a first electronic device having a plurality of widget software. The first electronic device includes a device description data. The device description data includes virtual units corresponding to the widget software, wherein the first electronic device establishes the virtual units in accordance with a universal plug and play (UPNP) protocol. The first electronic device searches a second electronic device through an network in accordance with the UPNP protocol and copies a first widget software of the widget software and a runtime data thereof to the second electronic device, and thus the second electronic device installs the first widget software and recovers the runtime data.

### RELATED APPLICATIONS

This application claims priority to Taiwan Application Serial Number 102142079 filed Nov. 19, 2013, which is herein incorporated by reference.

### BACKGROUND

1. Field of Invention

The present invention relates to a software roaming system. More particularly, the present invention relates to a software roaming system using an UPNP protocol.

2. Description of Related Art

With the development of information technology, network applications become more and more popular. For example, users can perform software roaming onto different electronic devices through a network. One type of the software roaming is to pre-install an application program onto two different electronic devices, in which the application program is performed by one electronic device, and the processing data of the application program are transmitted to another electronic device for processing. For example, this type of software roaming is typically applied on video streaming.

Another type of the software roaming is to copy the required data to a cloud services by the user, where the required data is performed by a pre-installed application program of an electronic device. However, pre-install the application program installed onto the electronic devices are required for these two types of software roaming for proper operation. Furthermore, in case the user wants to use the same data at different electronic devices, the user has to copy the required data and a configuration of the application program first to the different electronic devices, which is inconvenient for the user. Therefore, a heretofore-unaddressed need exists to address the aforementioned deficiencies and inadequacies.

### SUMMARY

One aspect of the present invention provides a software roaming method. The software roaming method includes following steps: respectively detecting a plurality of widgets of a first electronic device and a second electronic device, wherein the first electronic device is connected to the second electronic device through a network; establishing a first device description data in accordance with a universal plug and play (UPNP) protocol and the widgets of the first electronic device; establishing a second device description data in accordance with the universal plug and play protocol and the widgets of the second electronic device; selecting a first widget from the widgets of the first electronic device according to the first device description data and the second device description data; copying the first widget and a runtime data of the first widget from the first electronic device to the second electronic device; and installing the first widget to the second electronic device and recovering the runtime data.

According to one embodiment of the present invention, the first electronic device is a root device, which is configured to provide a software exchange service, each of the first device description data and the second device description data comprises a plurality of virtual units, wherein the virtual units of the first device description data are corresponding to the widgets of the first electronic device, and the virtual units of the second description data are corresponding to the widgets of the second electronic device.

According to one embodiment of the present invention, each of the virtual units provides an identification service and a content exchange service, the step of selecting the first widget from the widgets of the first electronic device comprises: comparing the first device description data and the second device description data to check whether the second electronic device has the virtual unit corresponding to the first widget; and selecting the first widget when the second electronic device does not have the virtual unit corresponding to the first widget.

According to one embodiment of the present invention, the step of selecting the first widget from the widgets of the first electronic device further comprises: identifying whether a software version of the first widget of the first electronic device and the software version of the first widget of the second electronic device are the same, by the identification service provided from the virtual unit, corresponding to the first widget of the second electronic device, when the second electronic device has the virtual unit corresponding to the first widget and selecting the first widget when the software version of the first widget of the first electronic device and the software version of the first widget of the second electronic device are different.

According to one embodiment of the present invention, the method further comprises: packaging and serializing the runtime data of the first electronic device, when the software version of the first widget of the first electronic device and the software version of the first widget of the second electronic device are the same; transferring the serialized runtime data to the second electronic device by the content exchange service corresponding to the first widget; and un-packaging and de-serializing the runtime data to recover the runtime data to the second electronic device.

According to one embodiment of the present invention, the step of copying the first widget comprises: packaging and serializing the runtime data and the first widget of the first electronic device; transferring the serialized first widget to the second electronic device by the software exchange service; and transferring the serialized runtime data to the second electronic device by the content exchange service corresponding to the first widget.

According to one embodiment of the present invention, the step of installing the first widget to the second electronic device comprises: un-packaging and de-serializing the first widget data and the runtime data to recover the first widget and the runtime data to the second electronic device.

Another one aspect of the present invention is to provide a computer readable medium, which is configured to perform a software roaming method. The software roaming method includes following steps: respectively detecting a plurality of widgets of a first electronic device and a second electronic device, wherein the first electronic device is connected to the second electronic device through a network; establishing a first device description data in accordance with a universal plug and play protocol and the widgets of the first electronic device; establishing a second device description data in accordance with the universal plug and play protocol and the widgets of the second electronic device; selecting a first widget from the widgets of the first electronic device according to the first device description data and the second device description data; copying the first widget and a runtime data of the first widget from the first electronic device to the second electronic device; and installing the first widget to the second electronic device and recovering the runtime data.

Yet another aspect of the present invention is to provide a software roaming system. The software roaming system includes a first electronic device having a plurality of widgets. The first electronic device includes a device description data. The device description data includes a plurality of virtual units, corresponding to the widgets, and the first electronic establishes the virtual units in accordance with a universal plug and play protocol. The first electronic device searches a second electronic device through an network and the universal plug and play protocol and copies a first widget of the widgets and a runtime data of the first widget to the second electronic device, so as to install the first widget and to recover the runtime data to the second electronic device.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a software roaming system in accordance with one embodiment of the present invention;

FIG. 2 is a flow chart of a software roaming method in accordance with one embodiments of the present invention;

FIG. 3 is a schematic diagram of the operation of first device description data and the second device description are established by the first electronic device and the second electronic device, in accordance with one embodiment of the present invention; and

FIG. 4 is a schematic diagram of operation of software roaming performed by the software roaming system in FIG. 1, in accordance with one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

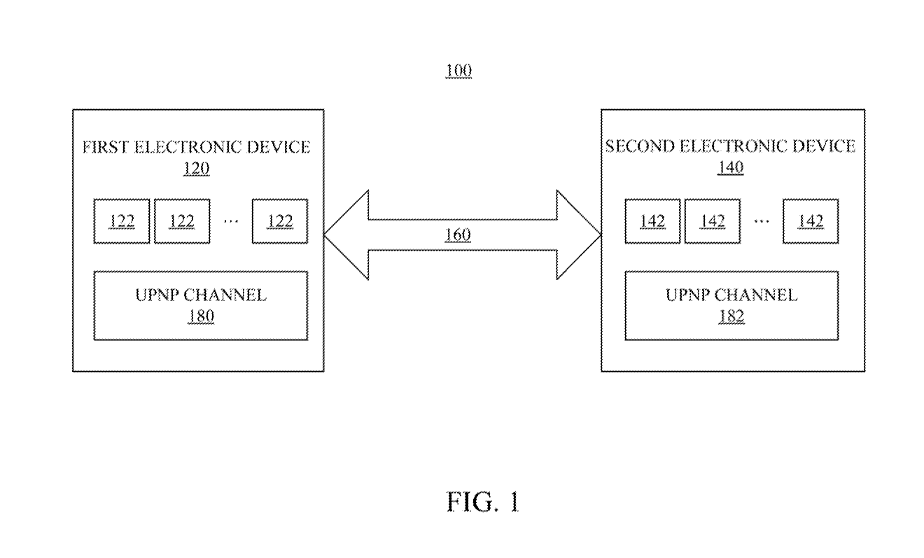

FIG. 1 is a schematic diagram of a software roaming system in accordance with one embodiment of the present invention. As shown in FIG. 1, the software roaming system 100 includes a first electronic device 120 and a second electronic device 140. The first electronic device 120 is connected to the second electronic device 140 through a network 160. In various embodiments of the present invention, each of the first electronic device 120 and the second electronic device 140 includes a personal computer, a smart phone, a smart TV, etc. The network 160 includes a network using a TCP/IP protocol, etc.

Furthermore, the first electronic device 120 has a plurality of widgets 122, and the second electronic device 140 has a plurality of widgets 142 as well.

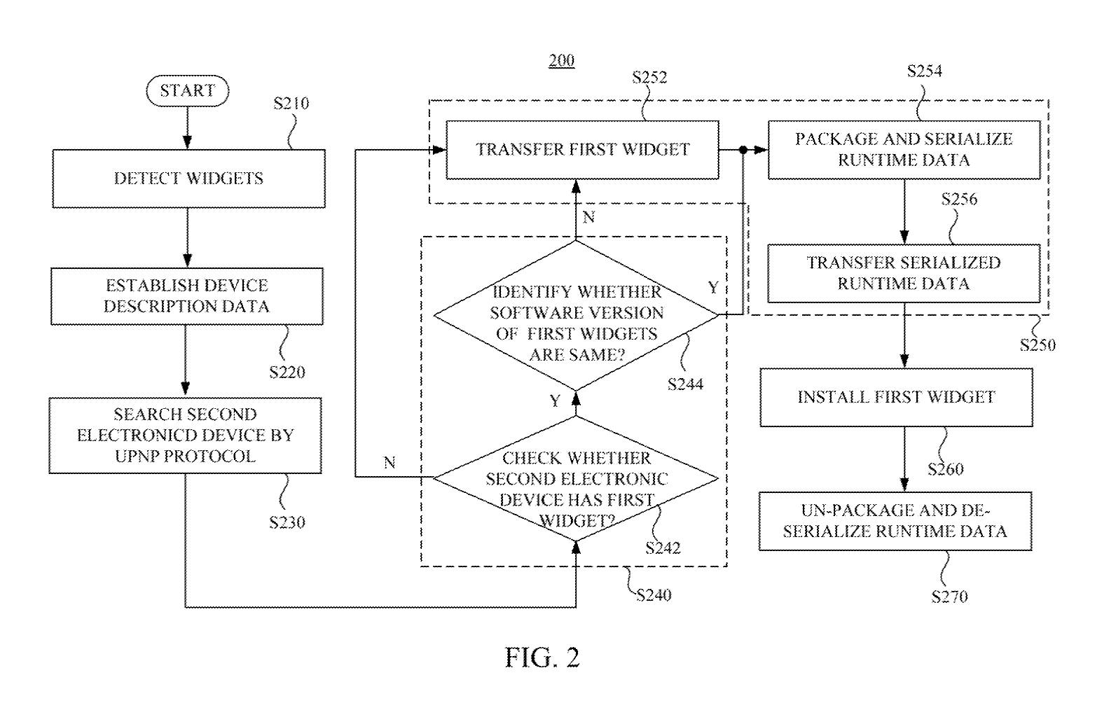

FIG. 2 is a flow chart of a software roaming method in accordance with one embodiments of the present invention. The software roaming method 200 may take the form of a computer program product stored on a computer-readable storage medium having computer-readable instructions embodied in the medium. The aforementioned computer can be a processing unit of the first electronic device 120, and the processing unit includes a central process unit, a control unit, a microprocessor, or the equivalents. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

Referring to both of FIG. 1 and FIG. 2, for illustration, the operations of the software roaming system 100 in FIG. 1 are described by the software roaming method 200 with reference to FIG. 2.

In operation S210, the first electronic device 120 and the second electronic device 140 respectively detects the widgets 122 and the widgets 142 thereof.

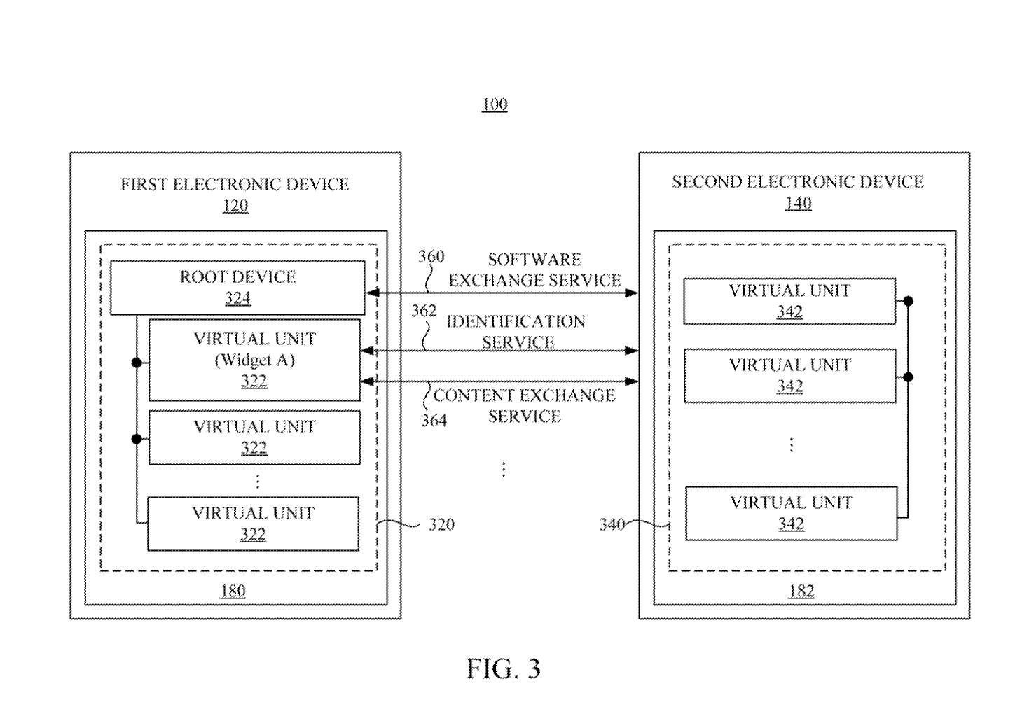

In operation S220, the first electronic device 120 and the second electronic device 140 respectively establishes a first device description data (e.g., shown as 320 in the FIG. 3) and a second device description data (e.g., shown as 340 in the FIG. 3) in accordance with a universal plug and play (UPNP) protocol and identifiable information of the widgets 122 and 142, such as a namespace, a software version, etc.

In this embodiment, the software roaming system 100 utilizes a standard of world wide web consortium for widgets to establish the first device description data 320 and the second device description data 340, and the first electronic device 120 and the second electronic device 140 are connected by using the UPNP protocol. Therefore, as shown in FIG. 1, the first electronic device 120 further includes an UPNP channel 180, and the second electronic device 140 further includes an UPNP channel 182.

In this example, the software roaming system 100 regards the first electronic device 120 as a root device. The root device is configured to define the descriptions among the devices or controllers. In other words, the software roaming system 100 or the software roaming method 200 of the present invention regards the widget as a virtual controller based on the UPNP protocol, thereby achieving the operations of software roaming.

FIG. 3 is a schematic diagram of the operation of first device description data and the second device description are established by the first electronic device and the second electronic device, in accordance with one embodiment of the present invention. For illustration, the following descriptions are described with reference to FIG. 1 to FIG. 3.

For example, as shown in FIG. 3, after the first electronic device 120 detects the widgets 122, the widgets 122 are transformed into a plurality of virtual units 322. Each of the virtual units 322 is named by the namespace of the corresponding widget 122. For instance, the namespace of a first widget 122 is widget A, and the corresponding virtual unit 322 is named as the widget A. Hence, the information of the virtual units 322 and the root device 324 are stored in the first device description data 320. The root device 324 is configured to provide a software exchange service 360, and each of the virtual units is configured to provide an identification service 362 and a content exchange service 364. Similarly, the second electronic device 140 performs the same operation described above, and the repetitious description will not be given here. The second device description data 340 includes the information of a plurality of virtual units 342, which are corresponding to the widgets 142.

In operation S230, the first electronic device 120 searches the second device description data 340 of the second electronic device 140 through the UPNP channel 182 and the network 160.

In operation S240, after searching the second device description data 340 of the second electronic device 140, the first electronic device 120 selects the first widget 122 (e.g., the aforementioned widget A).

For detailed illustration, in the operation S240, the first electronic device 120 compares the first device description data 340 and the second device description data 324, so as to check whether the second electronic device 140 has the virtual unit 324, corresponding to the first widget (widget A) (i.e., operation S242). For example, the first electronic device 120 compares the namespace of the virtual units 322 of the first device description data 320 and the namespace of the virtual units 342 of the second device description data 340, so as to check whether the first widget (widget A) exists in the second electronic device 140. The operation S244 is performed, when the second electronic device 140 has the first widget (widget A). Instead, the operation S250 is performed, when the second electronic device 140 does not have the first widget (widget A).

In operation S244, the first electronic device 120 identifies whether the software version of the first widget (widget A) of the first electronic device 120 and the software version of the first widget (widget A) of the second electronic device 140 are the same by the identification service provided from the virtual units 362, corresponding to the first widget (widget A) of the second electronic device 140. The operation S254 is performed, when the aforementioned software versions are the same. Instead, the operation S250 is performed, when the aforementioned software versions are different.

In operation S250, the first electronic device copies the first widget (widget A) and a runtime data of the first widget (widget A) to the second electronic device 140. The runtime data include a program configuration of the first widget (widget A) and the file using by the first widget (widget A). For example, the first widget (widget A) is a notepad program. The notepad program is editing a document file (i.e., the aforementioned runtime data), and the first electronic device 120 copies both of the notepad program and the document file to the second electronic device 140, and thus user can continuously edit the document file on the second electronic device 140.

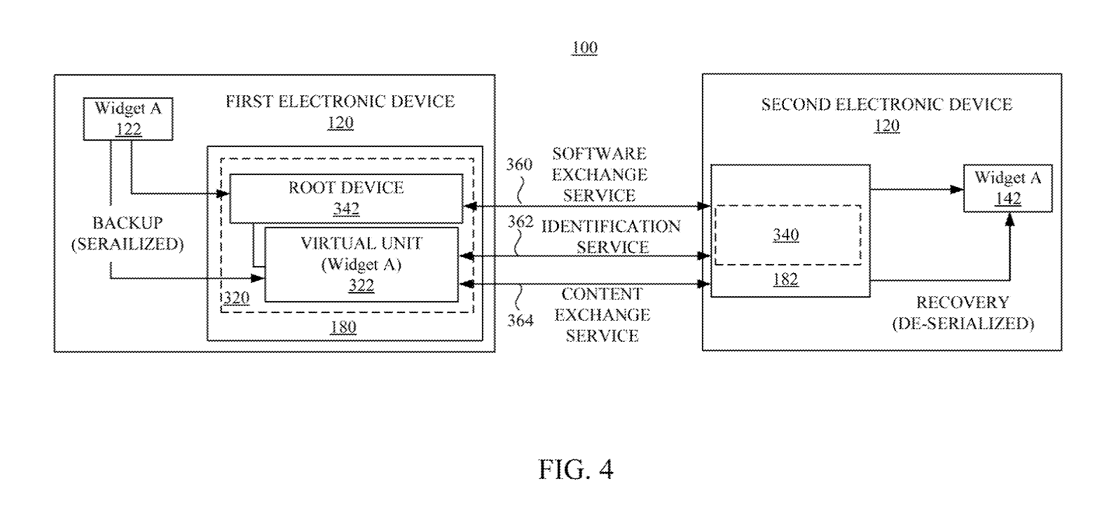

FIG. 4 is a schematic diagram of operation of software roaming performed by the software roaming system in FIG. 1, in accordance with one embodiment of the present invention. Specifically, as shown in FIG. 4, the first electronic device 120 transfers the first widget (widget A) to the second electronic device 140 through the UPNP channel 180 by using the aforementioned software exchange service 160 (i.e., operation S252).

Further, the first electronic device 120 packages and serializes the runtime data of the first widget (widget A) (i.e., operation S254) and transfers the serialized runtime data to the second electronic device 140 through the UPNP channel 180 (i.e., operation S256). In various embodiments of the present invention, the serialization performed by the first electronic device 120 includes a binary serialization, a XML serialization, a BASE64 serialization, etc.

Moreover, as mentioned by the operation S244, the first electronic device 120 performs the operation of copying the runtime data (i.e., the operation S254), when the first widget (widget A) of the second electronic device 140 and the first electronic device 120 are the same. Thus, user can use the same runtime data on the second electronic device 140.

As shown in FIG. 4, after the second electronic device 140 receives the runtime data and the first widget (widget A) transferred by the first electronic device 120, the second electronic device 140 installs the first widget (widget A) in itself (i.e., operation S260). The second electronic device 140 further un-packages and de-serializes the runtime data, so as to recover the runtime data (i.e., operation S270), and thus the user can use the same data with the same first widget (widget A) on the second electronic device 140.

According to the above, by using the software roaming system 100, user not only can use the same widget among the different electronic devices, but also can continuously use the same data among the different electronic devices.

In addition, the aforementioned software roaming system 100 or method 200 can applied to more than two of electronic devices. The aforementioned embodiments are described only for illustrative purpose, and the present invention is not limited thereof.

As mentioned above, the software roaming system 100 or the software roaming method 200 may be implemented in terms of software, hardware and/or firmware. For instance, if the execution speed and accuracy have priority, then the performance management system 100 may be implemented in terms of hardware and/or firmware. For illustration, if speed and accuracy are determined to be paramount, a hardware and/or firmware implementation is mainly selected and utilized. Alternatively, if flexibility is paramount, a software implementation is mainly selected and utilized. Furthermore, the software roaming system 100 may be implemented in terms of software, hardware and firmware in the same time. It is noted that the foregoing examples or alternates should be treated equally, and the present invention is not limited to these examples or alternates. Anyone who is skilled in the prior art can make modification to these examples or alternates in flexible way if necessary.

In summary, the software roaming system and the method described in the present invention can use the same widget among the different electronic devices by using the UPNP protocol, and the same data thereof can be continuously used.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A software roaming method, comprising:
respectively detecting a plurality of widgets of a first electronic device and a second electronic device, wherein the first electronic device is connected to the second electronic device through a network;
establishing a first device description data in accordance with a universal plug and play protocol and the widgets of the first electronic device;
establishing a second device description data in accordance with the universal plug and play protocol and the widgets of the second electronic device;
selecting a first widget from the widgets of the first electronic device according to the first device description data and the second device description data;
copying the first widget and a runtime data of the first widget from the first electronic device to the second electronic device; and
installing the first widget to the second electronic device and recovering the runtime data.

2. The software roaming method of claim 1, wherein the first electronic device is a root device configured to provide a software exchange service, each of the first device description data and the second device description data comprises a plurality of virtual units, wherein the virtual units of the first device description data are corresponding to the widgets of the first electronic device, and the virtual units of the second description data are corresponding to the widgets of the second electronic device.

3. The software roaming method of claim 2, wherein each of the virtual units provides an identification service and a content exchange service, the step of selecting the first widget from the widgets of the first electronic device comprising:
comparing the first device description data and the second device description data to check whether the second electronic device has the virtual unit corresponding to the first widget; and
selecting the first widget when the second electronic device does not have the virtual unit corresponding to the first widget.

4. The software roaming method of claim 3, wherein the step of selecting the first widget from the widgets of the first electronic device further comprises:
identifying whether a software version of the first widget of the first electronic device and the software version of the first widget of the second electronic device are the same by the identification service provided from the virtual unit, corresponding to the first widget of the second electronic device, when the second electronic device has the virtual unit corresponding to the first widget; and
selecting the first widget, when the software version of the first widget of the first electronic device and the software version of the first widget of the second electronic device are different.

5. The software roaming method of claim 4, further comprising:
packaging and serializing the runtime data of the first electronic device, when the software version of the first widget of the first electronic device and the software version of the first widget of the second electronic device are the same;
transferring the serialized runtime data to the second electronic device by the content exchange service corresponding to the first widget; and
un-packaging and de-serializing the runtime data to recover the runtime data to the second electronic device.

6. The software roaming method of claim 2, wherein the step of copying the first widget comprises:
packaging and serializing the runtime data and the first widget of the first electronic device;
transferring the serialized first widget to the second electronic device by the software exchange service; and
transferring the serialized runtime data to the second electronic device by the content exchange service corresponding to the first widget.

7. The software roaming method of claim 6, wherein the step of installing the first widget to the second electronic device comprises:
un-packaging and de-serializing the first widget data and the runtime data to recover the first widget and the runtime data to the second electronic device.

8. A computer readable medium for performing a software roaming method, the software roaming method comprising:
respectively detecting a plurality of widgets of a first electronic device and a second electronic device, wherein the first electronic device is connected to the second electronic device through a network;
establishing a first device description data in accordance with a universal plug and play protocol and the widgets of the first electronic device;
establishing a second device description data in accordance with the universal plug and play protocol and the widgets of the second electronic device;
selecting a first widget from the widgets of the first electronic device according to the first device description data and the second device description data;
copying the first widget and a runtime data of the first widget from the first electronic device to the second electronic device; and
installing the first widget to the second electronic device and recovering the runtime data.

9. The computer readable medium of claim 8, wherein the first electronic device is a root device and is configured to provide a software exchange service, each of the first device description data and the second device description data comprising a plurality of virtual units, wherein the virtual units of the first device description data are corresponding to the widgets of the first electronic device, and the virtual units of the second description data are corresponding to the widgets of the second electronic device.

10. The computer readable medium of claim 9, wherein each of the virtual units provides an identification service and a content exchange service, the step of selecting the first widget from the widgets of the first electronic device comprising:
comparing the first device description data and the second device description data to check whether the second electronic device has the virtual unit corresponding to the first widget; and
selecting the first widget when the second electronic device does not have the virtual unit corresponding to the first widget.

11. The computer readable medium of claim 10, wherein the step of selecting the first widget from the widgets of the first electronic device comprises:
identifying whether a software version of the first widget of the first electronic device and the software version of the first widget of the second electronic device are the same by the identification service provided from the virtual unit, corresponding to the first widget of the second electronic device, when the second electronic device has the virtual unit corresponding to the first widget; and
selecting the first widget, when the software version of the first widget of the first electronic device and the software version of the first widget of the second electronic device are different.

12. The computer readable medium of claim 11, wherein the method of the software roaming further comprises:
packaging and serializing the runtime data of the first electronic device, when the software version of the first widget of the first electronic device and the software version of the first widget of the second electronic device are the same;
transferring the serialized runtime data to the second electronic device by the content exchange service corresponding to the first widget; and
un-packaging and de-serializing the runtime data, so as to recover the runtime data to the second electronic device.

13. The computer readable medium of claim 9, wherein the step of copying the first widget comprises:
packaging and serializing the runtime data and the first widget of the first electronic device;
transferring the serialized first widget to the second electronic device by the software exchange service; and
transferring the serialized runtime data to the second electronic device by the content exchange service corresponding to the first widget.

14. The computer readable medium of claim 13, wherein the step of installing the first widget to the second electronic device comprises:
un-packaging and de-serializing the first widget data and the runtime data, so as to recover the first widget and the runtime data to the second electronic device.

15. A software roaming system, comprising:
a first electronic device having a plurality of widgets, the first electronic device comprising:
a device description data, comprising a plurality of virtual units corresponding to the widgets, wherein the first electronic establishes the virtual units in accordance with a universal plug and play protocol;
wherein the first electronic device searches a second electronic device through an network and the universal plug and play protocol, and copies a first widget of the widgets and a runtime data of the first widget to the second electronic device, so as to install the first widget and to recover the runtime data to the second electronic device.

16. The software roaming system of claim 15, wherein the first electronic device is configured to provide a software exchange service, and each of the virtual units is configured to provide an identification service and a content exchange service.

17. The software roaming system of claim 16, wherein the first electronic device checks whether the second electronic device has the virtual unit corresponding the first widget in accordance with device description data of the second electronic device, and the first electronic device selects the first widget when the second electronic device does not have the virtual unit corresponding to the first widget.

18. The software roaming system of claim 17, wherein the first electronic device identifies whether a software version of the first widget of the first electronic device and a software version of the first widget of the second electronic device are the same by the identification service provided from the virtual unit, corresponding to the first widget of the second electronic device, when the second electronic device has the virtual unit corresponding to the first widget, and the first electronic device selects the first widget of the first electronic devices, when the software version of the first widget of the first electronic device and the software version of the first widget of the second electronic device are different.

19. The software roaming system of claim 16, wherein the first electronic device packages and serializes the first widget and the runtime data, and the first electronic device transfers the serialized first widget to the second electronic device by the software exchange service, and transfers the serialized runtime data to the second electronic device by the content exchange service, corresponding to the first widget.

20. The software roaming system of claim 19, wherein the second electronic device is configured to un-package and de-serialize the runtime data and the first widget, so as to recover the runtime data and the first widget.
